(19) United States
(12) Patent Application Publication
(10) Pub. No.: US 2015/0044419 A1
(43) Pub. Date: Feb. 12, 2015

(54) COMPOSITE STRUCTURAL COMPONENT

(71) Applicant: Cutting Dynamics, Inc., Avon, OH (US)

(72) Inventors: William V. Carson, JR., Bay Village, OH (US); George Bielert, San Jose, CA (US); Rocco Deangelis, Lorain, OH (US)

(21) Appl. No.: 14/386,378

(22) PCT Filed: Mar. 22, 2013
(86) PCT No.: PCT/US2013/033464

§ 371 Date: Sep. 19, 2014

Related U.S. Application Data
(60) Provisional application No. 61/615,040, filed on Mar. 23, 2012.
(60) Provisional application No. 61/615,000, filed on Mar. 23, 2012.

(51) Int. Cl. B64D 11/06; B29C 45/14; B32B 3/26; B29C 45/16

(52) U.S. Cl. CPC B64D 11/06; B29C 45/1671; B29C 45/14786; B32B 3/266; B29C 2045/1681; B29C 2045/14885; B29C 2045/14877; B29L 2012/00
USPC 428/138; 264/259; 264/478; 264/265

(57) ABSTRACT

Disclosed in this specification is seat back frame comprising a thermoplastic matrix of randomly dispersed carbon fibers forming the structure, with the structure reinforced by affixing a pad up of a thermoplastic matrix comprising oriented fibers to the structure. Also disclosed is a method of manufacturing the seat back which comprises injection or overmolding the thermoplastic matrix comprised of randomly dispersed fibers onto the pad up which is a compression molded oriented fibers in the thermoplastic matrix.

### CROSS REFERENCES AND PRIORITIES

This application claims priority from U.S. Provisional Application No. 61/615,040 filed on 23 Mar. 2012 and U.S. Provisional Application No. 61/615,000 filed on 23 Mar. 2012, the teachings of both of which are incorporated in their entirety.

### BACKGROUND

Replacing metal and heavy parts with plastic parts is common. However, when the part takes on odd shapes or needs structural strength replacement with plastic becomes more difficult. The use of fibers to reinforce the plastic is a common practice, with oriented fibers known to be stronger than unoriented fibers.

One such challenging article is the seat frame used in airplanes. Seat frames must bear a large load. Imagine the frame locked to the floor, with a person sitting in it, and the person behind the seat grasping the seat and using it to assist lifting him or herself out of the seat. The amount of torque on the support or weakest spot of the frame is quite large.

Many have tried to make a seat back using thermoset composites reinforced with fibers. Thermoset composites are time consuming to process with low throughput and increased costs. Efforts to increase the time have resulted in increased weight of the final part, making it unappealing to the airline industry.

WO 2010 111700 published 30 Sep. 2010 discloses one method of incorporating oriented strength enhancing carbon fibers. This method used a pre-formed tube of the fibers in a thermoplastic matrix, expanded the tube in a heated mold allowing the thermoplastic to set up in the “U” shape of the seat back.

This method is expensive and overdesigns strength where strength is not needed.

### SUMMARY

Disclosed in this specification is an article of manufacture comprising a “U” shaped member comprising a first leg, a second leg, a top member, and at least one leg pad up; wherein the first leg comprises a first thermoplastic matrix comprised of randomly dispersed fiber types and the first leg has a first leg first end which is not connected with the top member and a first leg second end which is connected with the top member, the second leg is comprised of a second thermoplastic matrix comprised of randomly dispersed fiber types and the second leg has a second leg first end which is not connected with the top member and a second leg second end which is connected with the top member, with the top member connected to the first leg and the second leg to form the “U” shaped member wherein the “U” shaped member has a “U” shaped member horizontal plane defined by the first leg, the second leg and the top member with the “U” with the first leg having a first leg stress location and the second leg having a second leg stress location, and, the at least one leg pad up is comprised of oriented fiber types oriented in a plane in a third thermoplastic matrix with the leg pad up affixed to either the first or second leg.

In one embodiment the fiber types in the first thermoplastic matrix, the second thermoplastic matrix and the third thermoplastic matrix are each selected from the group consisting of glass fibers and carbon fibers. In a further embodiment the first and second thermoplastic matrix are the same.

In one embodiment leg pad up is affixed to either the first leg or second leg at the first leg stress location or the second leg stress location.

In one embodiment the third thermoplastic matrix is the same thermoplastic as the first thermoplastic matrix.

In one embodiment the article of manufacture comprises a melt bond between the third thermoplastic matrix of the leg pad up and either the first thermoplastic matrix of the first leg or the second thermoplastic matrix of the second leg.

In one embodiment the first leg, the second leg and the top member are connected as one continuous piece.

In one embodiment the at least one leg pad up has at least one leg pad up hole through and the first or second thermoplastic matrix passes through the at least one first leg pad up hole.

In one embodiment the at least one leg pad up is a compression molded part having at least one ply of oriented fibers. In another embodiment thermoplastic matrix of the first leg has been injection molded around the leg pad up.

Further disclosed in this specification is a process for structurally reinforcing a seat back, said process comprising melt bonding a leg pad up comprised of oriented fibers oriented in a plane within a third thermoplastic to a portion of a “U” defined by a first leg comprising randomly dispersed fibers in a first thermoplastic matrix, a second leg comprising randomly dispersed fibers in a second thermoplastic matrix, and a top member of the seat back.

In one embodiment the melt bonding is done during the manufacture of the portion of the “U” by injection molding the first or second thermoplastic with dispersed fibers of the portion of the “U” at the edge of or around the leg pad up.

In one embodiment the third thermoplastic of the leg pad up is the same thermoplastic as the thermoplastic used to manufacture the portion of the “U” to which the leg pad up is melt bonded.

In one embodiment the leg pad further comprises a hole through which thermoplastic used to manufacture the portion of the “U” to which the leg pad up is melt bonded will flow during the injection molding process.

### BRIEF DESCRIPTION OF FIGURES

FIG. 1 is a depiction of an embodiment of the claimed invention.

FIG. 2 is an expanded view of an embodiment of the claimed invention.

FIG. 3 is a cutaway view of an embodiment of the claimed invention.

FIG. 4 is a cutaway view of an embodiment of the claimed invention.

FIG. 5 is another depiction of an embodiment of the invention.

### DETAILED DESCRIPTION

This specification discloses an article of manufacture comprising a longitudinal section and at least one leg pad up wherein the longitudinal section is injection molded and affixed to the pad up which contains strength reinforcing oriented fibers.

The article of manufacture and process to manufacture the article relies upon the discovery that an injection moldable grade of thermoplastic comprising randomly dispersed or chopped fibers can be affixed to a thermoplastic composite having unidirectional oriented fibers in at least one ply by injection molding techniques such as injection molding, insert molding or over molding.

The article of manufacture comprises a single longitudinal section without adjoining structures. The longitudinal section will comprise a thermoplastic matrix comprised of randomly dispersed fibers. The longitudinal section will also comprise at least one pad-up for increased strength at a stress location.

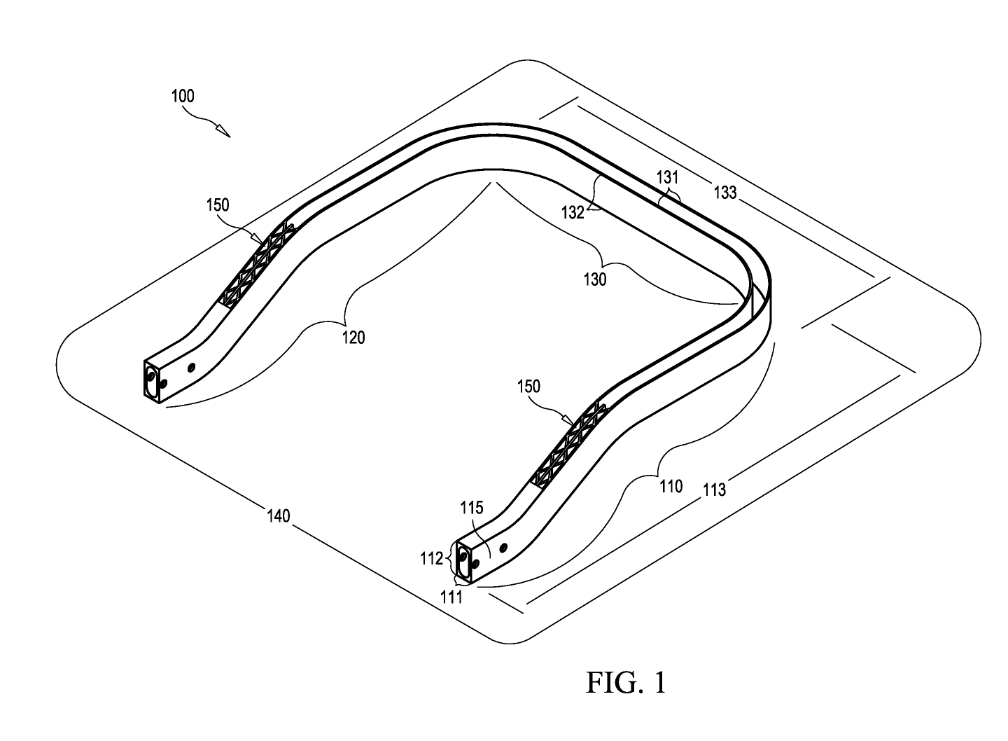

In one embodiment, the longitudinal section is formed into an airplane seat back. This general structure can be seen in FIG. 1 where 100 denotes the composite seat back frame. In such an embodiment, the longitudinal section will have a first leg section (110), a second leg section (120) and a top section (130). The first leg section will have a first leg section length dimension (113), a first leg section width dimension (111), a first leg section height dimension (112). The length dimension will be the longest dimension and is aligned with the direction of the spine of a person sitting in the seat. The width dimension is the dimension traveling perpendicular to the length dimension, lying in the “U” structure horizontal plane defined by the first leg section, the second leg section and the top section which connects or joins the first and second leg sections. The first and second leg section horizontal dimensions are perpendicular to the “U” structure horizontal plane.

The top section could be straight piece, or a curved piece that transitions from the second end of the first leg section, running in the “U” structure horizontal plane and then transitions into the second end of the second leg section.

It is preferred that the first leg section, the second leg section and the top section are all one single molded part and are connected by melt flow or melt bonding of the thermoplastic matrix material. In this instance, the first leg section, the second leg section and the top section are all comprised of the same thermoplastic matrix.

For clarity, the first leg section further will have a first leg section first end (115). The second leg section is usually of similar, or even like dimensional design as the first leg section. The second leg section will have a second leg section length dimension (123), a second leg section width dimension (121), a second leg section height dimension (122), wherein the second leg section length is the longest dimension of the second leg section, the second leg section further having a second leg section first end (125).

As mentioned earlier, the top section will have a top section length dimension (133), a top section width dimension (131), a top section height dimension (132), with the top section connected to the first leg section second end and the second leg section second end in a “U” structure having a “U” structure horizontal plane (140) defined by the first leg section, the second leg section. Thus the first and second leg section, lie in the “U” structure horizontal plane.

The first leg section and second leg section will each have at least one stress location defined respectively as the first leg section stress location and the second leg section stress location. The stress location of the respective leg depends upon the leg design and how the leg is locked or permanently fixed. The stress location is the point where the leg without the leg pad-up structurally fails when an increasing force is applied to the top section when the first and second leg sections are fixed so they do not move. Structurally fails mean that the leg is permanently distorted from its original shape, which is usually observed as a kink, a collapse, or the propagation of a crack. In general, the leg pad-up (150) should be located at the leg stress location.

The increasing force is applied perpendicular to the “U” shaped member horizontal plane. In a preferred embodiment, the legs are made of the same mirror design and same dimensions and materials, so a force applied at the middle of the top section should cause both legs to fail at the same time insubstantially the same place. However, this is often not the case, and the force can be varied at different points along the top section to cause the leg of interest to fail before the other leg. Should a leg not fail, then its stress location is at the leg end furthest from the top section.

Where the article of manufacture is an airplane seat back, the airplane seat back can have one or more leg pad-ups as shown in FIG. 5, known as a “pad-up” in molding parlance. The first leg section will have a first leg section pad-up (150A) with a first leg section pad-up length dimension (183), a first leg section pad-up width dimension (153), and a first leg section pad-up height dimension (152) affixed to the first leg section inside the first leg section and located at the first leg section stress location with the first leg section pad-up length dimension corresponding to the first leg section length dimension, the first leg section pad-up height dimension corresponding to the first leg section height dimension, and the first leg section width dimension corresponding to the first leg section width dimension.

Most likely there will be a second leg section pad-up (150C) having a second leg section pad-up length dimension, a second leg section pad-up width dimension, and a second leg section pad-up height dimension connected with the second leg section inside the second leg section and located at the second leg section stress location with the second leg section pad-up length dimension corresponding to the second leg section length dimension, the second leg section pad-up height dimension corresponding to the second leg section height dimension, and the second leg section width dimension corresponding to the second leg section width dimension;

The first leg section pad-up is comprised of a first thermoplastic and oriented fibers and the second leg section pad-up is comprised of a second thermoplastic and oriented fibers.

Although not necessary, the leg pad-up should have at least one hole or perforation (162), and it is preferable to have a plurality of perforations, at least some of which serve to physically locate the leg pad-up to the side of the leg. This could be the inside or outside of the leg. During molding formation of the leg, a portion of the thermoplastic material of the leg will extend or pass through at least some of perforations (162) embedding the edges of the perforations in the thermoplastic material extending there through, thereby fixedly attaching the leg pad-up to the leg as well as melt bonding the thermoplastic of the leg pad-up with the thermoplastic matrix of the leg. In another embodiment, the thermoplastic will mold through the perforations or apertures and form and bond with the thermoplastic material on the other side of the leg pad-up, thereby more permanently affixing or connecting the leg pad-up to the leg thermoplastic.

If more bonding is needed, the leg pad-up can be corona or flame treated to modify the surface area to make the thermoplastic of the leg pad-up more bondable with the thermoplastic of the leg. The best bond strength is expected when the matrix material of the leg pad-up is the same thermoplastic matrix of the leg. The increased strength of the assembly at the respective stress location will be in part a function of the number of holes or perforations in the leg pad-up, the diameter or thickness of the holes or perforations, and whether the material of the leg pad-up is corona or flame treated. The strength increase will also be a function of the length of the insert, the height of the insert, the width of the insert and the known structural strength relationships of oriented fibers, the degree of orientation, fiber choice and fiber density. Because the preferred manufacturing technique is injection molding, over molding or insert molding the leg pad-up to the leg, the leg pad-up is affixed to the leg by melt bonding during the molding process.

This type of melt bonding occurs when the thermoplastic of the leg pad-up is exposed to the molten thermoplastic of the leg or top section being injection molded, insert molded or over molded to or around the leg pad-up. For the best melt bonding, the thermoplastic materials should be the same. However, structurally similar materials will melt bond, but in general the melt point of the thermoplastic material of the leg pad-up should be greater or equal to the melt point of the thermoplastic of the leg or top section being injection molded, insert molded or over molded to or around the leg pad-up.

The leg pad-up will be made from a thermoplastic material or a thermoset material. As used herein and in the claims the term “thermoset plastic material” or “thermoset” means plastic materials having a three dimensional cross linked network resulting from the formation of covalent bonds between chemically reactive groups, e.g., active hydrogen groups and free isocyanate groups or oxirane groups. Thermoset plastic materials that may be fabricated include those known to the skilled artisan, e.g., cross linked polyurethanes, cross linked polyepoxides and cross linked polyesters. For purposes of illustration, a thermoset may be fabricated from cross linked polyurethanes by the art-recognized process of reaction injection molding. Reaction injection molding typically involves, as is known to the skilled artisan, injecting separately, and preferably simultaneously, into a mold: (i) an active hydrogen functional component (e.g., a polyol and/or polyamine); and (ii) a functional component that forms covalent bonds with the active hydrogen functional component, such as an isocyanate functional component (e.g., a diisocyanate such as toluene diisocyanate, and/or dimers and trimers of a diisocyanate such as toluene diisocyanate). The filled mold may optionally be heated to ensure and/or hasten complete reaction of the injected components.

Unlike the thermoset plastic, the leg pad-up, legs and top section are preferrably made of thermoplastic matrices. As used herein and in the claims, the term “thermoplastic material” or thermoplastic matrix means a plastic material or matrix that has a softening or melting point, and is substantially free (having less than 5% by weight of the plastic material as part of the thermoplastic matrix) of a three dimensional cross linked network resulting from the formation of covalent bonds between chemically reactive groups, e.g., active hydrogen groups and free isocyanate groups. The thermoplastic material may contain a dispersion of ground thermoset plastics, but the continuous matrix phase itself will be substantially free of thermoset materials.

Examples of thermoplastic materials from which the leg sections, the leg pad-up(s) and the top section may be fabricated include, but are not limited to, thermoplastic polyphenylene sulfide, thermoplastic polyetheretherketone, thermoplastic polyetherketoneketone, thermoplastic polyether imide, thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polypropylene, thermoplastic acrylonitrile-butadiene-styrene, thermoplastic polyethersulfone and mixtures or thermoplastic compositions containing one or more and their copolymers thereof.

Of the thermoplastic materials from which the leg sections, the leg pad-up(s), and the top section may be fabricated, thermoplastic polyamides and thermoplastic polysulfones are preferred. The leg sections or top section may be fabricated from thermoplastic materials by the art-recognized process of injection molding, in which a molten stream of thermoplastic material, e.g., molten thermoplastic polyamide, is injected into a mold, e.g., an optionally heated mold. In a preferred embodiment, the first leg section, second leg section, and top section are continuously connected and made from a single mold. In one embodiment, the pad-up(s) are made of a thermoset material while the leg sections and the top section are made of a thermoplastic material.

The thermoset plastic materials and/or thermoplastic materials from which the leg pad-up(s) may be fabricated, are preferably reinforced with a type of oriented fiber selected from the group consisting of glass fibers, carbon fibers, metal fibers, polyamide fibers and mixtures thereof. The reinforcing fibers, and the glass fibers in particular, may have sizings on their surfaces to improve miscibility and/or adhesion to the plastics into which they are incorporated, as is known to the skilled artisan.

Carbon fibers are a preferred reinforcing material in the present invention. If used, the reinforcement material, e.g., the fibers are typically present in the thermoset plastic materials and/or thermoplastic materials of the leg pad-up in a reinforcing amount, e.g., in an amount of from 5 percent by weight to 60 percent by weight, based on the total weight of the leg pad-up.

The carbon fibers used to form the leg pad-up may have an average fiber diameter of 4 micrometers to 12 micrometers. One suitable carbon fiber is from Zoltek Corporation of St Louis, Mo. USA, and has the trade name Panex 35. Other suitable carbon fibers are from Hexcel Corporation of Stamford, Conn. USA, and include AS4 carbon fibers and IM7 carbon fibers. The fiber volume fraction may be 0.5 to 0.7 of the composite leg pad-up. In the case of nano-fibers, diameters of 2 to 12 microns are typical.

To obtain the strength required, the fibers in the leg pad-up(s) are preferably continuous fibers and oriented or highly aligned in different parallel planes of the leg pad-up(s). These planes are also called plies. One method of manufacturing the thermoplastic leg pad-up(s) is to take a series of individual plies which are thermoplastic materials having oriented fibers running their length and lay the plies one on top of the other. The oriented fibers can have a different orientation of one ply relative to another ply. These various plies are often referred to as pre-pregs and are available on the open market, usually in rolls. Once the plies have been laid one on top of the other, heat and pressure can be applied to melt and press the plies together in a strong structural bond. This pressing could be done to create a flat sheet from which the leg pad-up(s) could be cut, or the plies could be precut, laid into a mold and the pressure and heat applied. A continuous manufacturing operation of this type is described in DE 4017978, the teachings of which are incorporated herein.

The oriented fiber in a ply may also be woven with fibers in the ply so that many fibers are aligned in a first direction, the other fibers are aligned in a direction different from the first direction, but in the same direction considered a second direction, passing over and under the fibers aligned in the first direction and are thus woven with the fibers aligned in the first direction.

The oriented fibers will form a plane within the thermoplastic matrix of the leg pad-up(s). If many plies of fibers are used, the plies will be separate planes. The oriented fibers will have an orientation direction. While the oriented fibers in one plane or ply may be rotated or offset relative to the oriented fibers in another plane or ply, at any given point in the pad-up, the oriented fibers in one ply will not be oriented in a direction that traverses into another ply. Often times only a uni-directional orientation is needed. It is also possible that the thermoplastic matrix used to surround the oriented fibers may further comprise chopped or dispersed fibers as well.

The thermoplastic materials from which the leg sections and/or the top section may be fabricated are often reinforced with a plurality of randomly dispersed fiber types selected from the group consisting of glass fibers, carbon fiberes, metal fibers, polyamide fibers and mixtures thereof. The plurality of randomly dispersed fiber types may be the same type of fiber as those of the oriented fibers in the pad-up thermoplastic matrix. In one such embodiment, the randomly dispersed fibers originate as pre-pregs and are chopped or cut into smaller, randomly dispersed fibers prior to being introduced to the leg section(s) and/or top section thermoplastic matrix.

When the leg pad-up is affixed to a leg the fibers are aligned so the plane lies substantially parallel to the side of the leg formed from the first end to the second end. Substantially parallel means that the plane is not perpendicular to the side of the leg, or does not pass through both sides of the leg in a perpendicular manner.

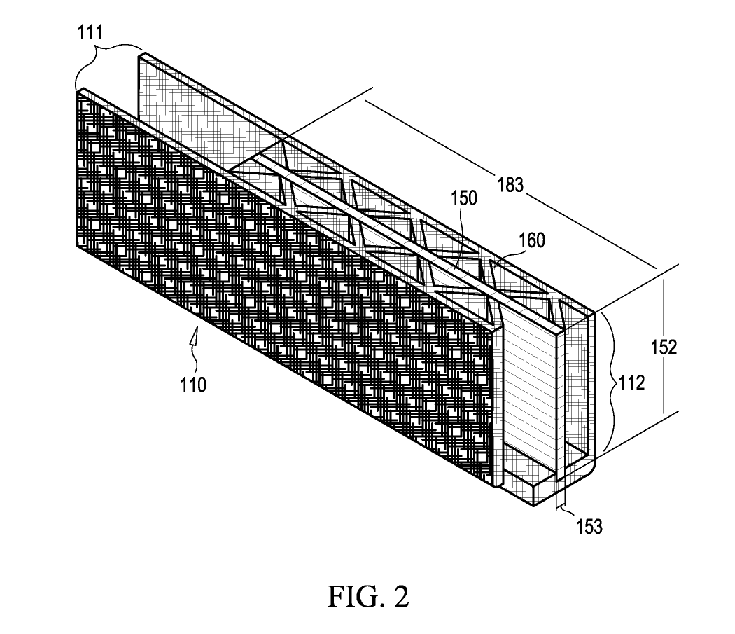

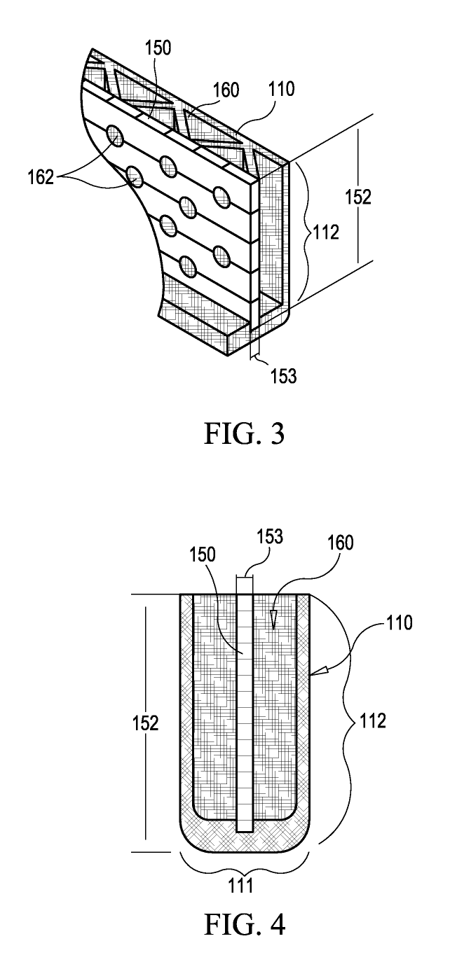

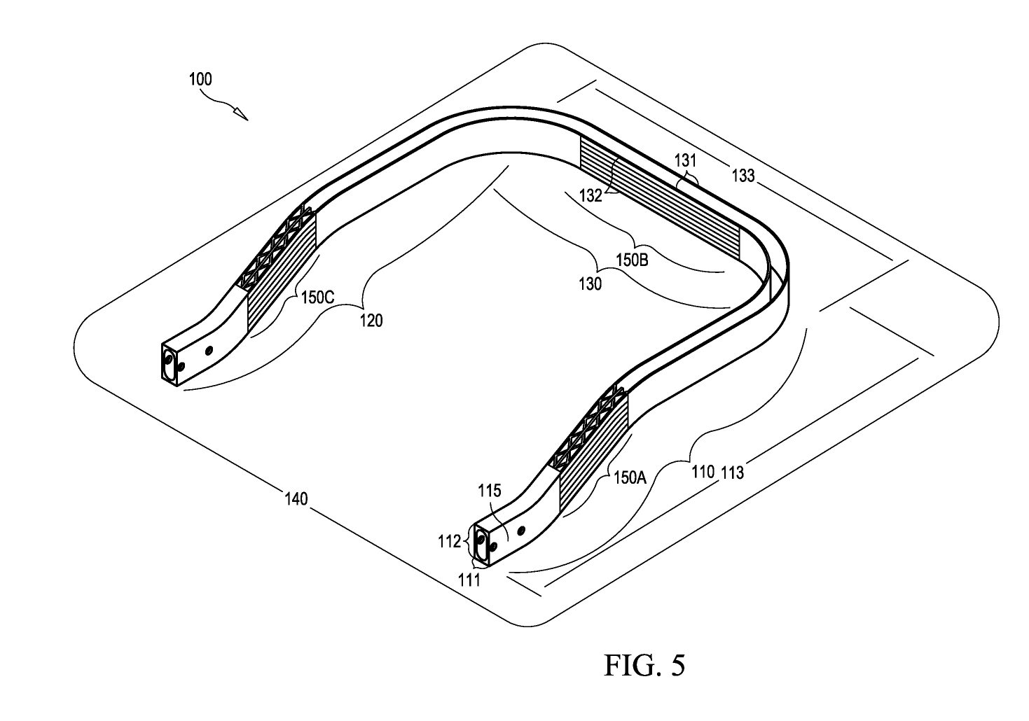

The structure of the legs may have numerous configurations or shapes. In a preferred embodiment of the present invention at least a portion of the leg comprises, a channel having a base or bottom and side walls, each having interior surfaces which define a hollow interior. The leg may also include a plurality of reinforcing ribs (FIG. 2, 160) located within the hollow interior of the channel. At least a portion of the reinforcing ribs are formed by molding of the thermoplastic material so that at least a portion of the plastic material extends through at least some of the perforations of the leg pad-up, These reinforcing ribs may have configurations selected from, but not limited to, X-like configurations, zig-zag configurations, curved or arcuate configurations, parallel configurations and combinations thereof.

In a preferred embodiment the leg pad-up(s) will have at least one hole or perforation and the ribs will pass through holes of the leg pad-up and be molded around the inserted leg pad-up. The pad-up hole or aperture does not have to be round, but could be of hexagonal or even rectangular or square design to prevent turning about the hole.

The actual molding of an injection moldable material around a pre-fabricated core or insert, such as a pad-up, is well known in the art. U.S. Pat. No. 6,251,323, incorporated herein by reference, describes how to totally encapsulate the pre-fabricated material. The background section of U.S. Pat. No. 6,251,323 describes various other types of injection molding processes to injection mold a material onto a prefabricated part, such as a leg pad-up.

It should be clear to one of ordinary skill how using the much stronger directionally oriented fibers of the leg pad-up placed at and into areas of stress locations allows for an injection molded seat back to be quickly made. The invention is not limited to the embodiments disclosed but to all equivalents using the principles taught herein.

FIG. 5 shows how the leg pad-up 150A, 150B, or top section pad-up 150C may be affixed to the outside of the leg or top section. In this instance the pad-up is placed on the outside of the wall of the mold and the thermoplastic matrix injection molded or over molded onto and through any holes of the leg pad-up.

Because this invention may use thermoplastics that are inherently flame retardant, the use of additional flame retardants is not considered necessary. Thus, the article of this invention is halogen free, meaning that the total amount of halogens which are not present as catalyst for the thermoplastic material, is less than 1% by weight of the total composition halogens. The amount of halogen is the amount of material as halogen, not the amount of Halogen compound.

Although particular embodiments of the invention have been described herein, it will be understood that the invention is not limited correspondingly in scope, but includes all changes and modifications coming within the spirit and terms of claims appended hereto. Particularly, the current invention is not limited to an airplane seat back frame, but encompasses any structural component which can be made of thermoplastic materials requiring lighter weight and increased strength.

Where the current invention is in the form of an airplane seat back, the structure of the legs may have numerous configurations or shapes. In a preferred embodiment of the present invention at least a portion of the leg comprises, a channel having a base or bottom and side walls, each having interior surfaces which define a hollow interior.

We claim:

1-16. (canceled)

17. An article of manufacture comprising a longitudinal section comprising:
a first thermoplastic matrix comprised of randomly dispersed fibers, and
at least one pad-up comprising a second thermoplastic matrix and oriented fibers wherein,
the at least one pad-up further comprises at least one hole, and
the first thermoplastic matrix passes through the at least one hole.

18. The article of manufacture of claim 17, wherein the randomly dispersed fibers and the oriented fibers are each a fiber type selected from the group consisting of glass fibers and carbon fibers.

19. The article of manufacture of claim 17, wherein the first thermoplastic matrix and the second thermoplastic matrix comprise a thermoplastic selected from the group consisting of polyphenylene sulphide, polyetherimide, polyetheretherketone, polyetherketoneketone, polyethylene terephthalate, polybutylene terephthalate, and polyethylene naphthalate and the guide thermoplastic matrix comprises a thermoplastic selected from the group consisting of polyphenylene sulphide, polyetherimide, polyetheretherketone, polyetherketoneketone, polyethylene terephthalate, polyester, polybutylene terephthalate, polyethylene naphthalate, polyethersulfone and combinations thereof.

20. The article of manufacture of claim 17, wherein the first thermoplastic matrix is the same thermoplastic as the second thermoplastic matrix.

21. The article of manufacture of claim 17, wherein the article of manufacture further comprises a melt bond between the first thermoplastic matrix and the second thermoplastic matrix.

22. The article of manufacture of claim 17, wherein the at least one pad-up is a compression molded part having at least one ply of oriented fibers.

23. The article of manufacture of claim 17, wherein the first thermoplastic matrix has been injection molded around the at least one pad-up.

24. The article of manufacture of claim 17, wherein the at least one pad-up is corona treated or flame treated.

25. A process for structurally reinforcing a longitudinal section, said process comprising:
melt bonding at least one pad-up comprised of oriented fibers oriented in a plane within a first thermoplastic matrix to a portion of a longitudinal section comprising randomly dispersed fibers in a second thermoplastic matrix wherein the at least one pad-up further comprises a hole through which the second thermoplastic matrix flows through.

26. The process of claim 25, wherein the melt bonding is done during the manufacture of the longitudinal section by injection molding the second thermoplastic with dispersed fibers at the edge of or around the at least one pad-up.

27. The process of claim 25, wherein the melt bonding is done during the manufacture of the longitudinal section by over molding the second thermoplastic with dispersed fibers at the edge of or around the at least one pad-up.

28. The process of claim 25, wherein the melt bonding is done during the manufacture of the longitudinal section by insert molding the second thermoplastic with dispersed fibers at the edge of or around the at least one pad-up.

29. The process of claim 25, wherein the first thermoplastic matrix and the second thermoplastic matrix comprise a thermoplastic selected from the group consisting of polyphenylene sulphide, polyetherimide, polyetheretherketone, polyetherketoneketone, polyethylene terephthalate, polybutylene terephthalate, and polyethylene naphthalate and the guide thermoplastic matrix comprises a thermoplastic selected from the group consisting of polyphenylene sulphide, polyetherimide, polyetheretherketone, polyetherketoneketone, polyethylene terephthalate, polyester, polybutylene terephthalate, polyethylene naphthalate, polyethersulfone and combinations thereof.

30. The process of claim 25, wherein the first thermoplastic matrix is the same thermoplastic as the second thermoplastic matrix.

31. The process of claim 25, wherein the randomly dispersed fibers and the oriented fibers are each a fiber type selected from the group consisting of glass fibers and carbon fibers.

32. The process of claim 25, wherein the at least one pad-up is corona treated or flame treated.
